(19) United States
(12) Patent Application Publication
(10) Pub. No.: US 2007/0035478 A1
(43) Pub. Date: Feb. 15, 2007

(54) Plasma display apparatus and method or driving the same

(75) Inventors: Dongki Paik, Seoul (KR); Jongrae Lim, Anyang-si (KR); Tae Heon Kim, Seoul (KR); Wootae Kim, Yongin-si (KR); Sung Chun Choi, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/500,880

(22) Filed: Aug. 9, 2006

(30) Foreign Application Priority Data
Aug. 9, 2005 (KR) 10-2005-0073027

(51) Int. Cl. G09G 3/28

(52) U.S. Cl. 345/67

(57) ABSTRACT

A plasma display apparatus and a method of driving the same are disclosed. The plasma display apparatus includes a plasma display panel including a scan electrode, a sustain electrode and an address electrode, a scan driver, a sustain driver and a data driver. The scan driver supplies a first pulse to the scan electrode during a sustain period. The sustain driver supplies a second pulse to the sustain electrode during the sustain period. The second pulse and the first pulse are alternately supplied. The data driver supplies a third pulse of a polarity opposite a polarity of the first pulse and the second pulse to the address electrode during the sustain period corresponding with the first pulse and the second pulse.

This Nonprovisional application claims priority under 35 U.S.C. § 119(a) on Patent Application No. 10-2005-0073027 filed in Korea on Aug. 9, 2005 the entire contents of which are hereby incorporated by reference.

### BACKGROUND OF THE INVENTION

1. Field of the Invention

This document relates to a display apparatus, and more particularly, to a plasma display apparatus and a method of driving the same.

2. Description of the Background Art

Out of display apparatuses, a plasma display apparatus comprises a plasma display panel and a driving apparatus for driving the plasma display panel.

The plasma display panel comprises a front panel, a rear panel and barrier ribs formed between the front panel and the rear panel. The barrier ribs forms unit discharge cell or discharge cells. Each of the discharge cell is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultra-violet rays, which thereby cause phosphors formed between the barrier ribs to emit light, thus displaying an image. Since the plasma display panel can be manufactured to be thin and light, it has attracted attention as a next generation display device.

The above-described plasma display panel has used a sustain pulse with a high voltage for its discharge.

In other words, the sustain pulse has used a sustain voltage (+Vs) based on a ground level voltage. When as described above, the plasma display panel starts to discharge and maintains the discharge using a high voltage, the plasma display panel requires a field effect transistor (FET) with a high voltage.

The use of the FET with the high voltage is a major factor of an increase in the price of the plasma display panel. When driving the plasma display panel under the high voltage, a driving error occurs such that there is a great likelihood of an erroneous discharge. Accordingly, various researches for reducing a driving voltage of the plasma display panel and stably driving the plasma display panel under the low power have been carried out.

There is a negative sustain method as a driving method of the plasma display panel using the low power.

FIG. 1 is a waveform diagram of a plasma display panel using a related art negative sustain method.

In the related art negative sustain method, before generating a surface discharge between a Y electrode and a Z electrode, an opposite discharge occurs between the Y electrode or the Z electrode and an X electrode. Charges generated by the opposite discharge functions as a seed charge such that the surface discharge occurs.

In the related art negative sustain method, since a negative voltage is applied to the Y electrode and the Z electrode and a ground level voltage is applied to the X electrode, positive charges move toward the Y electrode and the Z electrode. As a result, a protective layer made of MgO on the Y electrode and the Z electrode collides with the positive charges, thereby emitting secondary electrons.

The secondary electrons affect the surface discharge. In other words, the secondary electrons function as a seed charge of the surface discharge, thereby smoothly generating the surface discharge.

The opposite discharge occurs between the Y electrode or the Z electrode and the X electrode by a voltage difference between the Y electrode or the Z electrode and the X electrode. The opposite discharge increases a secondary electron emission coefficient, thereby further smoothly generating the surface discharge.

However, it is difficult to apply the related art negative sustain method to the plasma display panel in which a distance between the electrodes is wide. In other words, a distance between electrodes of most plasma display panels which have been now commercialized, ranges from about 50 μm to about 100 μm. Further, to increase discharge efficiency and stabilize a driving characteristic, recent plasma display panels has a long-gap structure in which a distance between electrodes is about 100 μm or more

When the related art negative sustain method is applied to the plasma display panel having the long-gap structure, it is difficult to lower a sustain voltage to a voltage equal to or less than a reference voltage and to stably drive the plasma display panel having the long-gap structure.

### SUMMARY OF THE INVENTION

Accordingly, an object of the present invention is to solve at least the problems and disadvantages of the background art.

An embodiment of the present invention provides a plasma display apparatus and a method of driving the same capable of lowering a driving voltage of the plasma display apparatus and being stably driving under the low power.

In an aspect, a plasma display apparatus comprises a plasma display panel comprising a scan electrode, a sustain electrode and an address electrode, a scan driver for supplying a first pulse to the scan electrode during a sustain period, a sustain driver for supplying a second pulse to the sustain electrode during the sustain period, the second pulse and the first pulse being alternately supplied, and a data driver for supplying a third pulse of a polarity opposite a polarity of the first pulse and the second pulse to the address electrode during the sustain period corresponding with the first pulse and the second pulse.

In another aspect, a plasma display apparatus comprises a plasma display panel comprising a scan electrode, a sustain electrode and an address electrode, a first driver for alternately supplying a first pulse of a negative polarity to the scan electrode and a second pulse of a negative polarity to the sustain electrode during a sustain period, and a second driver for supplying a third pulse of a positive polarity to the address electrode during the sustain period corresponding with the fist pulse and the second pulse.

In still another aspect, a method of driving a plasma display apparatus comprises supplying a reset pulse to a scan electrode during a reset period, alternately supplying a first pulse of a negative polarity to the scan electrode and a second pulse of a negative polarity to a sustain electrode during a sustain period, and supplying a third pulse of a positive polarity to an address electrode during the sustain period corresponding with the first pulse and the second pulse.

### BRIEF DESCRIPTION OF THE DRAWINGS

The invention will be described in detail with reference to the following drawings in which like numerals refer to like elements.

FIG. 1 is a waveform diagram of a plasma display panel using a related art negative sustain method;

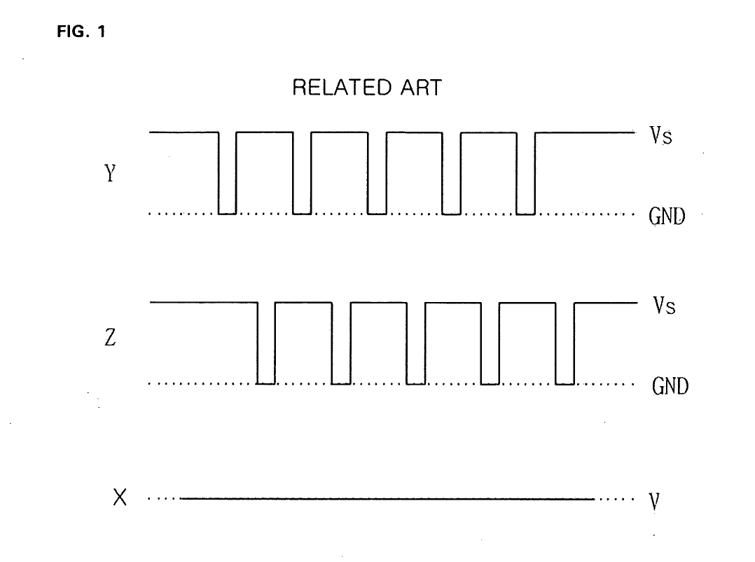

FIG. 2 illustrates a plasma display apparatus according to an embodiment of the present invention;

FIG. 3 illustrates an example of the structure of a plasma display panel in the plasma display apparatus according to the embodiment of the present invention;

FIGS. 4a and 4b illustrate a driving waveform generated by the plasma display apparatus according to the embodiment of the present invention; and

FIGS. 5a and 5b illustrate another driving waveform generated by the plasma display apparatus according to the embodiment of the present invention.

### DETAILED DESCRIPTION OF PREFERRED EMBODIMENTS

Preferred embodiments of the present invention will be described in a more detailed manner with reference to the drawings.

A plasma display apparatus according to an embodiment of the present invention comprises a plasma display panel comprising a scan electrode, a sustain electrode and an address electrode, a scan driver for supplying a first pulse to the scan electrode during a sustain period, a sustain driver for supplying a second pulse to the sustain electrode during the sustain period, the second pulse and the first pulse being alternately supplied, and a data driver for supplying a third pulse of a polarity opposite a polarity of the first pulse and the second pulse to the address electrode during the sustain period corresponding with the first pulse and the second pulse.

The first pulse and the second pulse may have a negative polarity, and the third pulse may have a positive polarity.

A magnitude of a voltage of the first pulse and a magnitude of a voltage of the second pulse may be substantially equal to a sustain voltage.

A magnitude of a voltage of the third pulse may be less than a magnitude of the voltage of the first pulse.

A sum of the magnitude of the voltage of the first pulse and a magnitude of a voltage of the third pulse may be more than the sustain voltage.

The third pulse may be supplied in synchronization with the first pulse and the second pulse.

The third pulse may be constantly supplied during the sustain period.

The number of third pulses supplied during the sustain period may be equal to a sum of the number of first pulses and the number of second pulses supplied during the sustain period.

A voltage frequency of the third pulse may be two times a voltage frequency of the first pulse.

A distance between the scan electrode and the sustain electrode may substantially range from 100 μm to 400 μm.

A plasma display apparatus according to the embodiment of the present invention comprises a plasma display panel comprising a scan electrode, a sustain electrode and an address electrode, a first driver for alternately supplying a first pulse of a negative polarity to the scan electrode and a second pulse of a negative polarity to the sustain electrode during a sustain period, and a second driver for supplying a third pulse of a positive polarity to the address electrode during the sustain period corresponding with the first pulse and the second pulse.

A magnitude of a voltage of the first pulse and a magnitude of a voltage of the second pulse may be equal to a sustain voltage.

A magnitude of a voltage of the third pulse may be less than a magnitude of the voltage of the first pulse.

A sum of the magnitude of the voltage of the first pulse and a magnitude of a voltage of the third pulse may be more than the sustain voltage.

The third pulse may be supplied in synchronization with the first pulse and the second pulse.

The third pulse may be constantly supplied during the sustain period.

The number of third pulses supplied during the sustain period may be equal to a sum of the number of first pulses and the number of second pulses supplied during the sustain period.

A voltage frequency of the third pulse may be two times a voltage frequency of the first pulse.

A distance between the scan electrode and the sustain electrode may substantially range from 100 μm to 400 μm.

A method of driving a plasma display apparatus according to an embodiment of the present invention comprises supplying a reset pulse to a scan electrode during a reset period, alternately supplying a first pulse of a negative polarity to the scan electrode and a second pulse of a negative polarity to a sustain electrode during a sustain period, and supplying a third pulse of a positive polarity to an address electrode during the sustain period corresponding with the first pulse and the second pulse.

Hereinafter, exemplary embodiments of the present invention will be described in detail with reference to the attached drawings.

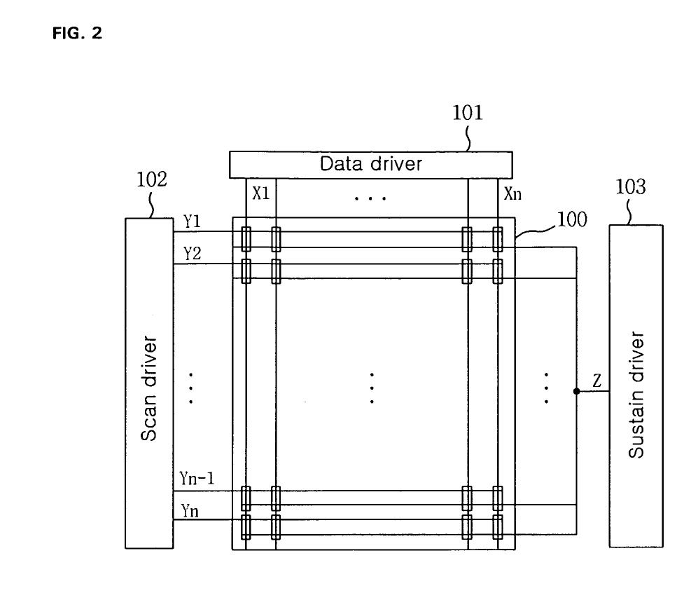

FIG. 2 illustrates a plasma display apparatus according to an embodiment of the present invention.

As illustrated in FIG. 2, the plasma display apparatus according to the embodiment of the present invention comprises a plasma display panel 100 and a driver for supplying a predetermined driving voltage to electrodes of the plasma display panel 100, preferably, a data driver 101, a scan driver 102 and a sustain driver 103.

The scan driver 102 and the sustain driver 103 may be called a first driver, and the data driver 101 maybe called a second driver.

A front panel (not shown) and a rear panel (not shown) of the plasma display panel 100 are coalesced with each other at a given distance. A plurality of electrodes, for example, a plurality of scan electrodes Y and a plurality of sustain electrodes are formed in the plasma display panel 100.

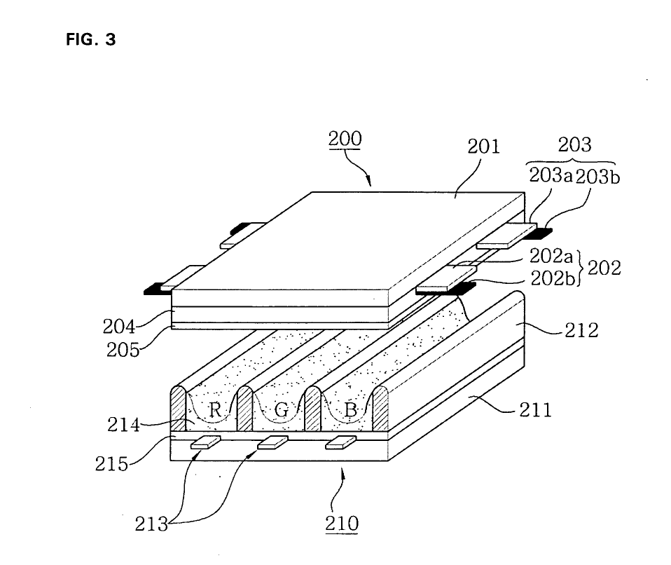

The following is a detailed description of the structure of the plasma display panel 100, with reference to FIG. 3.

FIG. 3 illustrates an example of the structure of a plasma display panel in the plasma display apparatus according to the embodiment of the present invention.

As illustrated in FIG. 3, the plasma display panel 100 of the plasma display apparatus according to the embodiment of the present invention comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed. A plurality of address electrodes 213 are arranged on the rear substrate 111 to intersect the scan electrodes 202 and the sustain electrodes 203.

The scan electrode 202 and the sustain electrode 203 each comprise transparent electrodes 202a and 203a made of transparent indium-tin-oxide (ITO) material and bus electrodes 202b and 203b made of a metal material. The scan electrode 202 and the sustain electrode 203 generate a mutual discharge therebetween in one discharge cell and maintain light-emissions of the discharge cells.

The scan electrode 202 and the sustain electrode 203 are covered with one or more upper dielectric layers 204 to limit a discharge current and to provide insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are formed in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear substrate 211 is coated with Red (R), green (G) and blue (B) phosphors 214 for emitting visible light for an image display when an address discharge is performed. A lower dielectric layer 215 is formed between the address electrodes 213 and the phosphors 214 to protect the address electrodes 213.

Only an example of the plasma display panel applicable to the embodiment of the present invention was illustrated in FIG. 3. Accordingly, the embodiment of the present invention is not limited to the structure of the plasma display panel illustrated in FIG. 3.

For example, in FIG. 3, the scan electrode 202 and the sustain electrode 203 each comprise the transparent electrode and the bus electrode. However, at least one of the scan electrode 202 and the sustain electrode 203 may comprise either the bus electrode or the transparent electrode.

Further, the structure of the plasma display panel, in which the front panel 200 comprises the scan electrode 202 and the sustain electrode 203 and the rear panel 210 comprises the address electrode 213, is illustrated in FIG. 3. However, the front panel 200 may comprise all of the scan electrode 202, the sustain electrode 203 and the address electrode 213. At least one of the scan electrode 202, the sustain electrode 203 and the address electrode 213 may be formed on the barrier rib 212.

Considering the structure of the plasma display panel 100 of FIG. 3, the plasma display panel 100 applicable to the embodiment of the present invention has only to comprise the scan electrode 202, the sustain electrode 203 and the address electrode 210. The plasma display panel 100 may have various structures except the above-described structural characteristic.

The description of FIG. 3 is completed, and the description of FIG. 2 continues again.

The scan driver 102 supplies a setup pulse and a set-down pulse to the scan electrode Y of the plasma display panel 100 during a reset period. Further, the scan driver 102 supplies a scan pulse to the scan electrode Y during an address period, and supplies a first pulse being a sustain pulse of a negative polarity to the scan electrode Y during a sustain period.

The sustain driver 103 supplies a second pulse being a sustain pulse of a negative polarity to the sustain electrode Z of the plasma display panel 100 during the sustain period. During the sustain period, the scan driver 102 and the sustain driver 103 alternately supply the first pulse and the second pulse.

The data driver 101 supplies a data pulse with a data voltage to the address electrode X of the plasma display panel 100 during the address period. The data driver 101 supplies a third pulse synchronized with both the first pulse and the second pulse to the address electrode X during the sustain period. The fist pulse, the second pulse and the third pulse will be described in detail below.

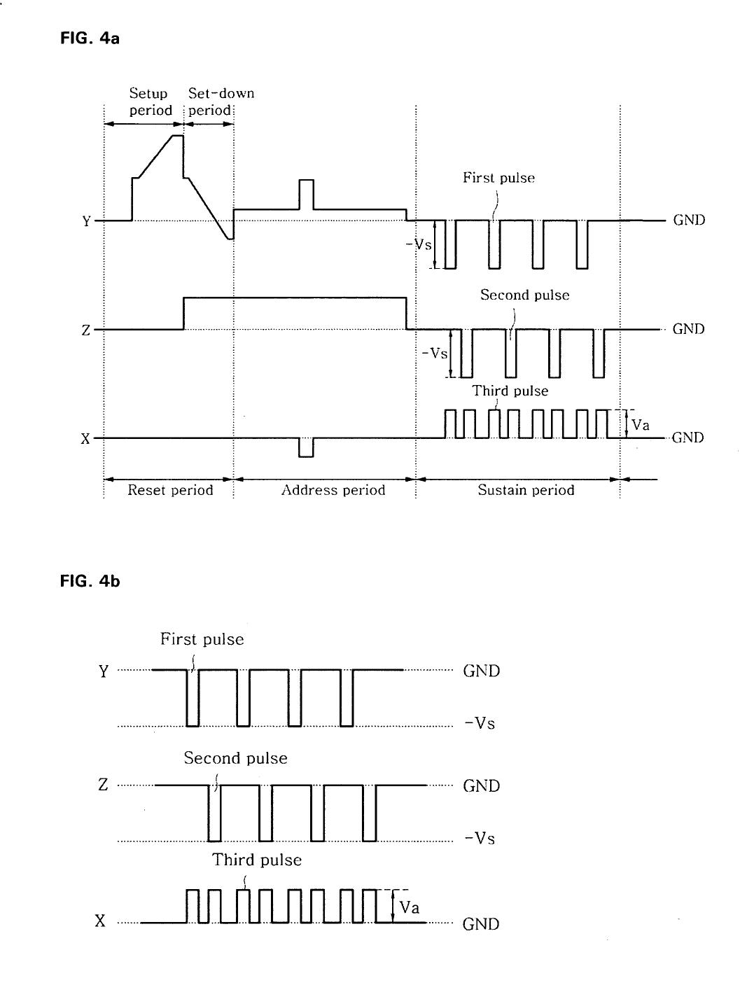

FIGS. 4a and 4b illustrate a driving waveform generated by the plasma display apparatus according to the embodiment of the present invention.

As illustrated in FIG. 4a, during the sustain period, the first pulse with a negative sustain voltage −Vs and the second pulse with a negative sustain voltage −Vs are supplied to the scan electrode Y and the sustain electrode Z, respectively, and the third pulse with a positive voltage Va is supplied to the address electrode X in synchronization with both the first pulse and the second pulse. The negative sustain voltage −Vs ranges from −200V to −160V.

A magnitude of a voltage (i.e., −Vs−Va) subtracting the positive voltage Va of the third pulse from the negative sustain voltage −Vs of the first pulse or the negative sustain voltage −Vs of the second pulse is more than a magnitude of a sustain voltage Vs.

A voltage frequency of the third pulse is two times a voltage frequency of the first pulse or a voltage frequency of the second pulse.

It is preferable that the number of third pulses is equal to a sum of the number of first pulses and the number of second pulses.

The first pulse and the second pulse have the voltage of the same polarity, i.e., the negative sustain voltage. The polarity of the voltage of the first pulse and the second pulse is opposite to the polarity of the voltage of the third pulse.

In other words, when the first pulse and the second pulse are supplied to the scan electrode Y and the sustain electrode Z, the third pulse with the positive voltage opposite the negative voltage of the first pulse and the second pulse is supplied to the address electrode X thereby reducing a magnitude of the negative sustain voltage. In particular, in the plasma display panels having the structure, in which a distance between the electrodes ranges from about 100 μm to about 400 μm, for increasing discharge efficiency and stabilizing a driving characteristic, the sustain voltage can be lowered to a voltage equal to or less than a reference voltage and the plasma display panel having the above-described structure can be driven efficiently and stably.

As illustrated in FIG. 4b, when the first pulse with the negative sustain voltage −Vs and the second pulse with the negative sustain voltage −Vs are supplied to the scan electrode Y and the sustain electrode Z, respectively during the sustain period, the third pulse with the positive voltage Va is supplied to the address electrode X.

The third pulse maybe supplied in synchronization with the first pulse and the second pulse.

In the related art plasma display panel, a distance between a scan electrode and a sustain electrode ranges from 60 μm to 80 μm. The structure of a plasma display panel, in which a distance between a scan electrode and a sustain electrode ranges from 100 μm to 400 μm, is called a long-gap structure or a wide-gap structure. At this time, it is known that a driving margin can greatly increase by supplying a sustain pulse with a negative sustain voltage −Vs to the scan electrode and the sustain electrode.

If the distance between the scan electrode and the sustain electrode widens, a sustain voltage increases. However, in the plasma display apparatus according to the embodiment of the present invention, a magnitude of the negative sustain voltage −Vs supplied during the sustain period can be reduced by supplying the third pulse with the positive voltage to the address electrode X.

The polarity of the voltage of the second pulse supplied to the sustain electrode Z is opposite to the polarity of the voltage of the third pulse supplied to the address electrode X.

A magnitude of a voltage (i.e., −Vs−Va) subtracting the positive voltage Va of the third pulse from the negative sustain voltage −Vs of the second pulse is more than a magnitude of a sustain voltage Vs. Accordingly, a magnitude of the negative sustain voltage −Vs can be reduced.

A voltage frequency of the third pulse is two times a voltage frequency of the second pulse. It is preferable that a magnitude of the voltage of the third pulse is less than a magnitude of the voltage of the first pulse.

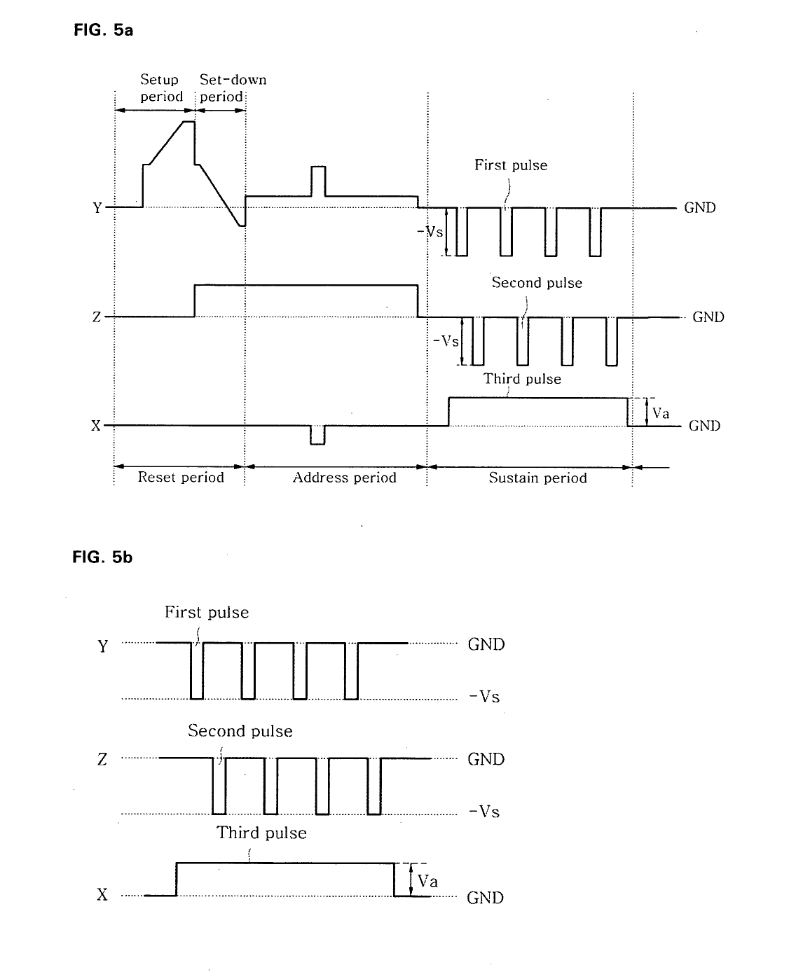

FIGS. 5a and 5b illustrate another driving waveform generated by the plasma display apparatus according to the embodiment of the present invention.

As illustrated in FIG. 5a, when the first pulse with the negative sustain voltage −Vs and the second pulse with the negative sustain voltage −Vs are supplied to the scan electrode Y and the sustain electrode Z, respectively during the sustain period, the third pulse with the positive voltage Va is supplied to the address electrode X.

The third pulse with the positive voltage Va is constantly supplied to the address electrode X during the supply of the first pulse and the second pulse to the scan electrode Y and the sustain electrode Z.

The negative sustain voltage −Vs ranges from −200V to −160V.

A magnitude of a voltage (i.e., −Vs−Va) subtracting the positive voltage Va of the third pulse from the negative sustain voltage −Vs of the first pulse or the negative sustain voltage −Vs of the second pulse is more than the magnitude of the sustain voltage Vs.

The first pulse and the second pulse have the voltage of the same polarity, i.e., the negative sustain voltage. The polarity of the voltage of the first pulse and the second pulse is opposite to the polarity of the voltage of the third pulse.

In other words, when the first pulse and the second pulse are supplied to the scan electrode Y and the sustain electrode Z, the third pulse with the positive voltage opposite the negative voltage of the first pulse and the second pulse is supplied to the address electrode x, thereby reducing the magnitude of the negative sustain voltage.

In particular, in the plasma display panels having the structure in which a distance between the electrodes ranges from about 100 μm to about 400 μm, for increasing discharge efficiency and stabilizing a driving characteristic, the sustain voltage can be lowered to a voltage equal to or less than a reference voltage and the plasma display panel having the above-described structure can be driven efficiently and stably.

As illustrated in FIG. 5b, when the first pulse with the negative sustain voltage −Vs and the second pulse with the negative sustain voltage −Vs are supplied to the scan electrode Y and the sustain electrode Z, respectively during the sustain period, the third pulse with the positive voltage Va is constantly supplied to the address electrode X.

In the related art plasma display panel, a distance between a scan electrode and a sustain electrode ranges from 60 μm to 80 μm. The structure of a plasma display panel, in which a distance between a scan electrode and a sustain electrode ranges from 100 μm to 400 μm, is called a long-gap structure or a wide-gap structure. At this time, it is known that a driving margin can greatly increase by supplying a sustain pulse with a negative sustain voltage −Vs to the scan electrode and the sustain electrode.

If the distance between the scan electrode and the sustain electrode widens, the sustain voltage increases. However, in the plasma display apparatus according to the embodiment of the present invention, a magnitude of the negative sustain voltage −Vs supplied during the sustain period can be reduced by supplying the third pulse with the positive voltage to the address electrode X.

The polarity of the voltage of the second pulse supplied to the sustain electrode Z is opposite to the polarity of the voltage of the third pulse supplied to the address electrode X.

A magnitude of a voltage (i.e., −Vs−Va) subtracting the positive voltage Va of the third pulse from the negative sustain voltage −Vs of the second pulse is more than a magnitude of a sustain voltage Vs. Accordingly, a magnitude of the negative sustain voltage −Vs can be reduced.

It is preferable that a magnitude of the voltage of the third pulse is less than a magnitude of the voltage of the first pulse.

As described above, in the embodiment of the present invention, when the sustain pulse of the negative polarity is supplied to the scan electrode and the sustain electrode, the pulse of the positive polarity opposite the negative polarity of the sustain pulse is supplied to the address electrode, thereby reducing the magnitude of the voltage of the sustain pulse of the negative polarity.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode, a sustain electrode and an address electrode;
a scan driver for supplying a first pulse to the scan electrode during a sustain period;
a sustain driver for supplying a second pulse to the sustain electrode during the sustain period, the second pulse and the first pulse being alternately supplied; and
a data driver for supplying a third pulse of a polarity opposite a polarity of the first pulse and the second pulse to the address electrode during the sustain period corresponding with the first pulse and the second pulse.

2. The plasma display apparatus of claim 1, wherein the first pulse and the second pulse have a negative polarity, and the third pulse has a positive polarity.

3. The plasma display apparatus of claim 2, wherein a magnitude of a voltage of the first pulse and a magnitude of a voltage of the second pulse are substantially equal to a sustain voltage.

4. The plasma display apparatus of claim 3, wherein a magnitude of a voltage of the third pulse is less than a magnitude of the voltage of the first pulse.

5. The plasma display apparatus of claim 3, wherein a sum of the magnitude of the voltage of the first pulse and the magnitude of a voltage of the third pulse is more than the sustain voltage.

6. The plasma display apparatus of claim 2, wherein the third pulse is supplied in synchronization with the first pulse and the second pulse.

7. The plasma display apparatus of claim 2, wherein the third pulse is constantly supplied during the sustain period.

8. The plasma display apparatus of claim 2, wherein the number of third pulses supplied during the sustain period is substantially equal to a sum of the number of first pulses and the number of second pulses supplied during the sustain period.

9. The plasma display apparatus of claim 2, wherein a voltage frequency of the third pulse is two times a voltage frequency of the first pulse.

10. The plasma display apparatus of claim 2, wherein a distance between the scan electrode and the sustain electrode substantially ranges from 100 μm to 400 μm.

11. A plasma display apparatus comprising:
a plasma display panel comprising a scan electrode, a sustain electrode and an address electrode;
a first driver for alternately supplying a first pulse of a negative polarity to the scan electrode and a second pulse of a negative polarity to the sustain electrode during a sustain period; and
a second driver for supplying a third pulse of a positive polarity to the address electrode during the sustain period corresponding with the first pulse and the second pulse.

12. The plasma display apparatus of claim 11, wherein a magnitude of a voltage of the first pulse and a magnitude of a voltage of the second pulse are substantially equal to a sustain voltage.

13. The plasma display apparatus of claim 12, wherein a magnitude of a voltage of the third pulse is less than a magnitude of the voltage of the first pulse.

14. The plasma display apparatus of claim 12, wherein a sum of the magnitude of the voltage of the first pulse and a magnitude of a voltage of the third pulse is more than the sustain voltage.

15. The plasma display apparatus of claim 12, wherein the third pulse is supplied in synchronization with the first pulse and the second pulse.

16. The plasma display apparatus of claim 12, wherein the third pulse is constantly supplied during the sustain period.

17. The plasma display apparatus of claim 12, wherein the number of third pulses supplied during the sustain period is substantially equal to a sum of the number of first pulses and the number of second pulses supplied during the sustain period.

18. The plasma display apparatus of claim 12, wherein a voltage frequency of the third pulse is two times a voltage frequency of the first pulse.

19. The plasma display apparatus of claim 12, wherein a distance between the scan electrode and the sustain electrode substantially ranges from 100 μm to 400 μm.

20. A method of driving a plasma display apparatus comprising:
supplying a reset pulse to a scan electrode during a reset period;
alternately supplying a first pulse of a negative polarity to the scan electrode and a second pulse of a negative polarity to a sustain electrode during a sustain period; and
supplying a third pulse of a positive polarity to an address electrode during the sustain period corresponding with the first pulse and the second pulse.
